(19) United States
(12) Patent Application Publication
(10) Pub. No.: US 2009/0157692 A1
(43) Pub. Date: Jun. 18, 2009

(54) Filename segmentation based client server file management system

(75) Inventor: Jan Reinhardt, Pittsburgh, PA (US)

Correspondence Address: Jan Reinhardt, Apt. 16B, 342 S Highland Avenue, Pittsburgh, PA, 15206, US

(73) Assignee: Jan Reinhardt, Pittsburgh, PA (US)

(21) Appl. No.: 11/974,159

(22) Filed: Oct. 12, 2007

(51) Int. Cl. G06F 17/30; G06F 7/00; G06F 3/048

(52) U.S. Cl. 707/10; 707/200; 707/102; 715/700; 707/E17.01; 707/E17.044; 707/E17.032

(57) ABSTRACT

In the client server based file management system the filename contains segments delimited by a specified character that describe the content of the file with respect to different dimensions. Upon uploading the file from the client application to the server the file can be associated with entries of a file schema. Users may filter the system for files that satisfy specified criteria for specified dimensions.

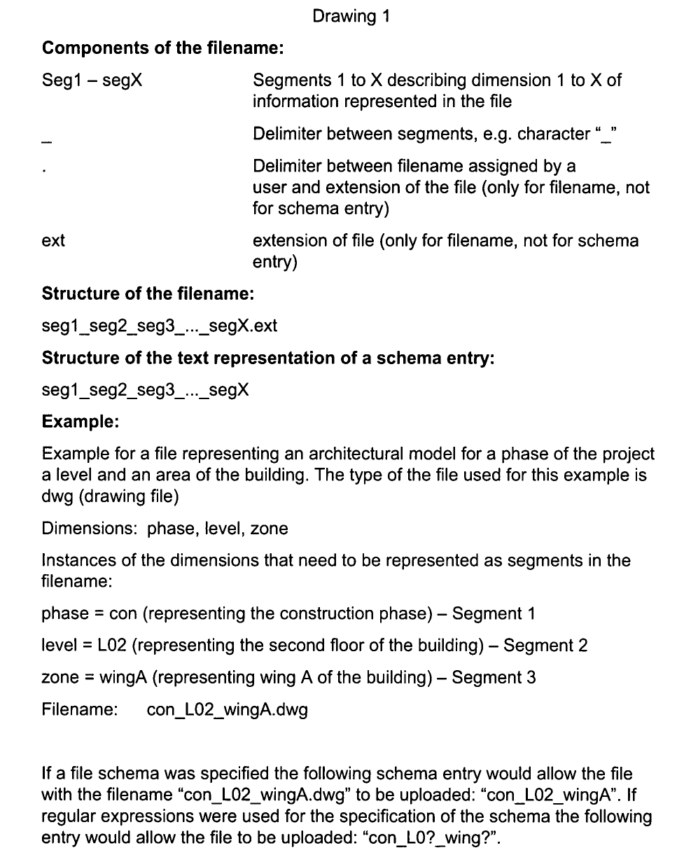

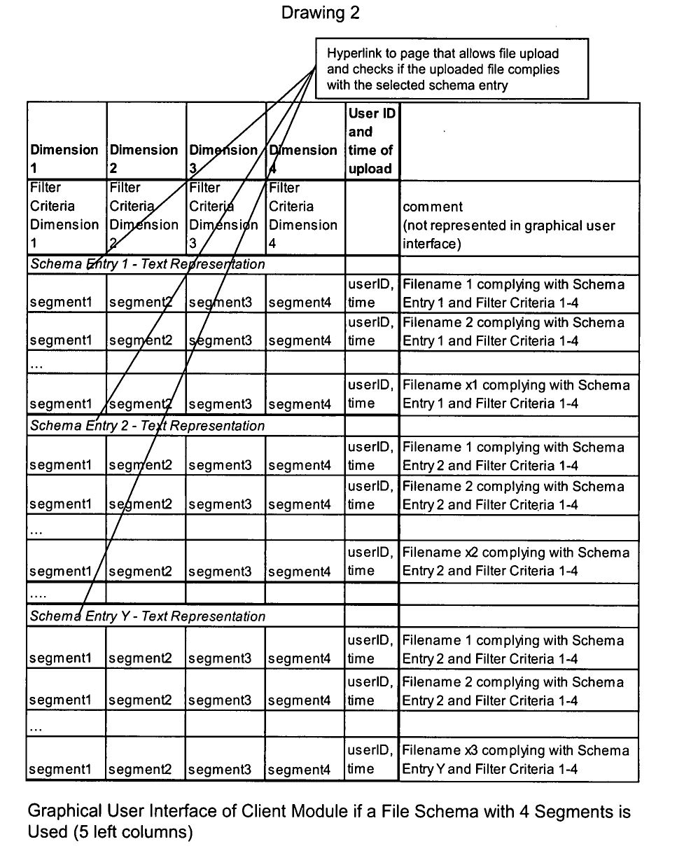

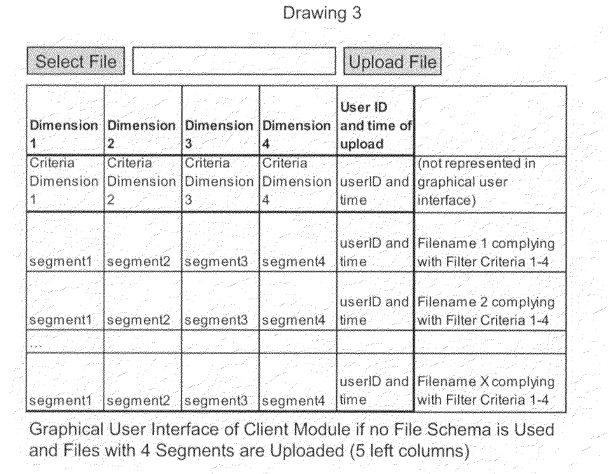

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The invention described in this document pertains to file management systems for project management tasks in the field of construction, mechanical engineering and process engineering.

### BRIEF SUMMARY OF THE INVENTION

The client server based file management system supports work groups that share files to efficiently store files on a server that is accessible by all work group members. By specifying the content of the file in the segments of the filename the system can automatically classify the file and make it accessible to filter mechanisms. Describing the content of the file in multiple segments of the filename eliminates the process of describing the content of the file in a separate step of the file uploading process and allows the system to classify the file based on the dimensions described in the segments of the filename.

### BRIEF DESCRIPTION OF THE SEVERAL VIEWS OF THE DRAWING

Drawing 1: Components and structure of the filename

Drawing 2: Presentation of files on client application with specified file schema

Drawing 3: Presentation of files on client application with no specified file schema

### DETAILED DESCRIPTION OF THE INVENTION

The system is used to manage files. It consists of a Server Module that stores files and a Client Module is used by a user of the system to upload files to the server and to download files from the server. The server module can be accessed by one or many client modules. The server module and the client module can reside on one computer and may be incorporated into one single application or can be set up as a distributed system, such as a web server acting as the server module and a browser acting as the client module. The filename of a file that is to be uploaded to the server is divided into segments by a designated delimiter string. The segments of the filename describe dimensions of the content of the file. A dimension described in a segment of the filename is determined by the position of the segment in the filename. Drawing 1 illustrates the structure of the filenames that the system requires. The client-server system allows the user to filter files uploaded to the server by specifying one or many instances of dimensions of the file that was uploaded to the server and needs to be accessed. This is achieved by specifying the instances of segments that pertain to the various desired dimensions of a file. The specification of the desired dimensions of a file can be accomplished by selection from a list of available instances of segments that correspond to the desired dimensions based on the files uploaded to the server or by text based input including regular expressions. Based on the user specification of segments for the desired filename the system will filter the uploaded files and present the files that meet the specified filter criteria to the user. The filter criteria for an uploaded file are met if all segments specified by the user in the filtering process agree with a file in text or regular expression and position of the segments.

The server module allows the administrator of the system to specify admissible filenames or classes of admissible filenames that a user can upload to the server module. The multitude of admissible filenames or classes of admissible filenames is referred to as the file schema. A representation of an admissible filename or a class of admissible filenames in the file schema is referred to as a schema entry. A schema entry consists of text or regular expressions describing the segments and pre-specified delimiters between the segments. If a file schema is specified the system will not accept files uploaded by a user that do not agree with one of the schema entries. A schema entry contains segments and delimiters. If a file schema is specified the client module will present the schema entries to the user as well as the filenames of the files or classes of files uploaded to the server component that correspond with the schema entries. Drawing 2 shows how the schema entries and the corresponding files are represented in the graphical user interface of the client module.

The server module creates internal representations for each file uploaded to the server, for schema entries, for files attempted to be uploaded to the server module as well as for filter criteria. Multiple files of the same filename can be uploaded to the server. The Server will distinguish the files based on the filename, the identity of the user and the time when the file was uploaded. If the user works in a context in which a file schema is used the internal representation of the file attempted to be uploaded is matched against the schema entries. If the internal representation of this file complies with one schema entry the upload is finalized. If this file agrees with no schema entry the upload is rejected.

1) A file filtering system consisting of a server module for file storage and one or many client modules for user file upload to the server module and file access from the server module where the filename of a file uploaded to the server consists of two or more segments separated by a pre-specified delimiter string; the segments describe dimensions describing the content of the uploaded file, the user can create a filtered view of the files uploaded to the server by specifying zero to many segments that correspond to the filename of a file that the user desires to retrieve.

2) A file management system of claim 1) where the client module and the server module are embedded into one application.

3) A file management system of claim 1) where the client module is an internet browser.

4) A file management system of claim 1) that provides a file schema, consisting of a multitude of schema entries that are internal representations of filenames or classes of filenames that are admissible to be uploaded to the server module, where the schema entries are represented as a filename consisting of segments and delimiters with segments represented as text or regular expressions.

5) A file management system of claim 4) that uses a client module with a graphical user interface in which files represent the segments of the filename in tabular format and rows representing schema entries preceding the rows of the filenames or classes of filenames of uploaded files associated with that schema entry, as described in Drawing 2.

6) A file management system of claim 4) that uses a client module with a graphical user interface in which files represent the segments of the filename in tabular format and rows representing schema entries preceding the rows of the filenames or classes of filenames of uploaded files associated with that schema entry, as described in Drawing 3.
